(19) United States
(12) Patent Application Publication
(10) Pub. No.: US 2023/0196369 A1
(43) Pub. Date: Jun. 22, 2023

(54) IDENTIFYING SUSPICIOUS BEHAVIOR BASED ON PATTERNS OF DIGITAL IDENTIFICATION DOCUMENTS

(71) Applicant: International Business Machines Corporation, Armonk, NY (US)

(72) Inventors: Jason Malinowski, Mahopac, NY (US); Swaminathan Balasubramanian, Troy, MI (US); Cheranellore Vasudevan, Bastrop, TX (US); Genevieve van den Boer, Richmond (CA); Thomas G. Lawless, III, Wallkil, NY (US); Gordan G. Greenlee, Endicott, NY (US)

(21) Appl. No.: 17/555,883

(22) Filed: Dec. 20, 2021

(51) Int. Cl. G06Q 20/40

(52) U.S. Cl. CPC G06Q 20/4016; G06Q 20/4014; G06Q 20/405; G06Q 20/407

(57) ABSTRACT

A computer-implemented method, system and computer program product for identifying suspicious behavior. Requests to provide digital identification (ID) document(s) to a computing device of a verifier by a computing device of a consumer based on a validation context are detected. Responses to such requests are also detected in which the computing device of the consumer provides digital ID document(s) to the computing device of the verifier. A score is then generated corresponding to a likelihood of fraud in the transaction involving the consumer and the verifier using an artificial intelligence model based on the validation context, the digital ID document(s) requested to be provided by the computing device of the consumer and the digital ID document(s) provided to the computing device of the verifier. The computing device of the verifier may then be informed that there is evidence of fraud based on a value of the score.

### TECHNICAL FIELD

The present disclosure relates generally to fraud detection systems, and more particularly to identifying suspicious behavior based on patterns of digital identification (ID) documents, such as digital ID documents requested by a verifier and provided by a consumer.

### BACKGROUND

Fraud detection is a set of processes and analyses that allow organizations to identify and prevent unauthorized activities. Such unauthorized activities may include fraudulent credit card transactions, identity theft, cyber hacking, insurance scams, and more.

With an unlimited and rising number of ways someone can commit fraud, detection can be difficult. Activities, such as reorganization, moving to new information systems or encountering a cybersecurity breach could weaken an organization's ability to detect fraud. Techniques, such as real-time monitoring for fraud is generally recommended.

### SUMMARY

In one embodiment of the present disclosure, a computer-implemented method for identifying suspicious behavior comprises detecting requests to provide one or more digital identification (ID) documents to a computing device of a verifier by a computing device of a consumer based on a validation context. The method further comprises detecting responses to the requests in which the computing device of the consumer provides one or more digital ID documents to the computing device of the verifier. The method additionally comprises generating a score corresponding to a likelihood of fraud in a transaction involving the consumer and the verifier using an artificial intelligence model based on the validation context, the one or more digital ID documents requested to be provided by the computing device of the consumer to the computing device of the verifier and the one or more digital ID documents provided to the computing device of the verifier by the computing device of the consumer. Furthermore, the method comprises informing the computing device of the verifier that there is evidence of fraud based on a value of the score.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the authentication system for identifying alternative digital ID documents to be provided to the verifier in order to complete the verification process in determining if the consumer meets the ID requirements for an associated activity or event in accordance with an embodiment of the present disclosure;

FIG. 3 is a diagram of the software components used by the fraud service broker for detecting anomalous or suspicious behavior based on patterns of digital ID documents in accordance with an embodiment of the present disclosure.

FIG. 4 illustrates an embodiment of the present disclosure of the hardware configuration of the authentication system which is representative of a hardware environment for practicing the present disclosure;

FIG. 5 is a flowchart of a method for creating an artificial intelligence model to generate a score corresponding to a likelihood of fraud in a transaction involving the consumer and the verifier in accordance with an embodiment of the present disclosure; and

FIGS. 6A-6B are a flowchart of a method for detecting suspicious behavior based on the pattern of digital ID documents requested and provided in the transaction involving the verifier and the consumer in accordance with an embodiment of the present disclosure.

### DETAILED DESCRIPTION

As stated in the Background section, fraud detection is a set of processes and analyses that allow organizations to identify and prevent unauthorized activities. Such unauthorized activities may include fraudulent credit card transactions, identity theft, cyber hacking, insurance scams, and more.

With an unlimited and rising number of ways someone can commit fraud, detection can be difficult. Activities, such as reorganization, moving to new information systems or encountering a cybersecurity breach could weaken an organization's ability to detect fraud. Techniques, such as real-time monitoring for fraud is generally recommended.

Fraud detection systems typically search for patterns or anomalies of suspicious behavior as a general focus for fraud detection. Such patterns and anomalies of suspicious behavior are detected based on current data or device use patterns. For example, data analysts may attempt to prevent insurance fraud by creating algorithms to detect patterns and anomalies of suspicious behavior based on current data or device use patterns.

Unfortunately, by simply detecting patterns and anomalies of suspicious behavior based on current data or device use patterns, many fraudulent activities will not be detected.

The embodiments of the present disclosure provide a means for detecting suspicious behavior based on patterns of digital ID documents, such as digital ID documents requested by the verifier and provided by the consumer.

In some embodiments of the present disclosure, the present disclosure comprises a computer-implemented method, system and computer program product for identifying suspicious behavior. In one embodiment of the present disclosure, requests to provide digital identification (ID) document(s) to a computing device of a verifier by a computing device of a consumer based on a validation context are detected. “Validation context,” as used herein, refers to the circumstances that determine which ID requirements should be requested of the consumer by the verifier. For example, in order to validate the state in which the consumer lives, the verifier may request the consumer to provide a license or vehicle registration. In such an example, the validation context corresponds to validating the state in which the consumer lives. A “consumer” (also referred to as the “device holder”), as used herein, refers to the individual who desires to partake in an activity or event but is required to present digital identification (ID) documents to the verifier (e.g., government agency) to prove that the consumer meets the ID requirements to engage in such an activity or event, such as proof of age, residence, location, etc. “Verifier,” as used herein, refers to the entity (e.g., government agency, government official, merchant, etc.) that is responsible for verifying that the consumer meets the ID requirements for partaking in an associated activity or event. A “digital ID document,” as used herein, is an electronic equivalent of an individual identity card as well as other forms of user information, such as pay stubs, utility bills, restaurant receipts, etc. Furthermore, in addition to detecting requests to provide digital ID document(s) to the computing device of the verifier, responses to such requests are detected in which the computing device of the consumer provides digital ID document(s) to the computing device of the verifier. A score is then generated corresponding to a likelihood of fraud in the transaction involving the consumer and the verifier using an artificial intelligence model based on the validation context, the digital ID document(s) requested to be provided by the computing device of the consumer to the computing device of the verifier and the digital ID document(s) provided to the computing device of the verifier by the computing device of the consumer. The computing device of the verifier may then be informed that there is evidence of fraud based on a value of the score, such as when the value of the score does not meet or exceed a threshold value. In this manner, suspicious behavior is detected based on the pattern of digital ID documents requested and provided in the transaction involving the verifier and the consumer.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

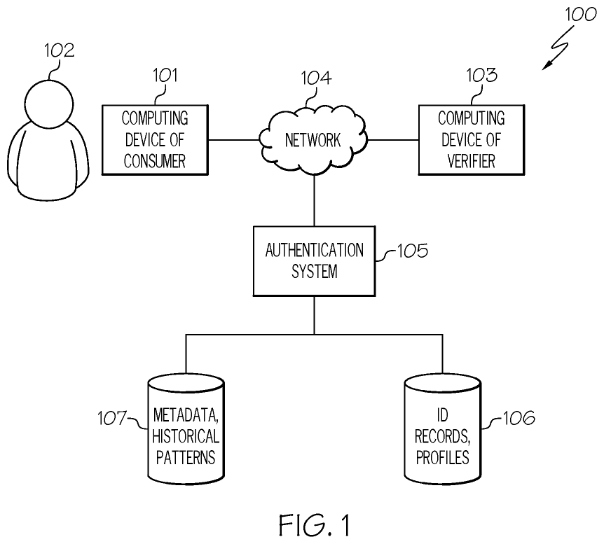

Referring now to the Figures in detail, FIG. 1 illustrates an embodiment of the present disclosure of a communication system 100 for practicing the principles of the present disclosure. Communication system 100 includes a computing device 101 of a consumer 102 (also referred to herein as the “device holder”) connected to a computing device 103 of a “verifier” via a network 104. Consumer (“device holder”) 102, as used herein, refers to the individual who desires to partake in an activity or event but is required to present digital identification (ID) documents to the verifier (e.g., government agency) to prove that consumer 102 meets the ID requirements to engage in such an activity or event, such as proof of age, residence, location, etc. “Verifier,” as used herein, refers to the entity (e.g., government agency, government official, merchant, etc.) that is responsible for verifying that consumer 102 meets the ID requirements for partaking in an associated activity or event. A “digital ID document,” as used herein, is an electronic equivalent of an individual identity card as well as other forms of user information, such as pay stubs, utility bills, restaurant receipts, etc. A digital ID document can be presented electronically to the verifier to prove an individual's identity and/or their right to partake in an activity or event or to access information or services. Furthermore, the digital ID document can include attributes selected by the user to be presented to the verifier, such as the age of the user, thereby preventing other information that was not selected by the user (e.g., home address) from being shared to the verifier.

Computing devices 101, 103 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 104 and consequently communicating with verifiers and consumers 102, respectively.

Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Furthermore, network 104 may consist of a wireless network to support wireless technology standards or protocols, such as Bluetooth and near-field communication. Other networks, whose descriptions are omitted here for brevity, may also be used in conjunction with system 100 of FIG. 1 without departing from the scope of the present disclosure.

Furthermore, as shown in FIG. 1, system 100 includes an authentication system 105 connected to network 104 via wire or wirelessly. Authentication system 105 is configured to identify alternative digital ID documents to be provided to the verifier in order to complete the verification process in determining if consumer 102 meets the ID requirements for an associated activity or event as discussed further below. In connection with identifying such alternative digital ID documents, authentication system 105 may utilize “ID records” that include historical data of acceptable credentials and their contexts which are stored in database 106 connected to authentication system 105.

“ID records,” as used herein, refer to the collection of digital ID documents, including alternative digital ID documents, that were provided by consumers, such as consumer 102 of FIG. 1, to verifiers. “Alternative digital ID documents,” as used herein, refer to digital ID documents (e.g., pay sub issued in the last 7 days) that are requested by the verifier to be provided by the consumer, such as consumer 102, in replace of the digital ID documents (e.g., debit card of a designated bank) that were originally requested by the verifier to be provided by the consumer. Furthermore, such ID records include information, such as the type of transaction (referred to herein also as the “client type”). The “type of transaction,” as used herein, refers to the categorization of the consumer (e.g., government employee) involved in the communication with the verifier. For example, the transaction between the verifier and consumer 102 may involve consumer 102 being a government employee. Additionally, such ID records may include the purpose for verifying that consumer 102 meets the ID requirements for an associated activity or event, such as opening a checking account. Furthermore, such ID records include a listing of digital ID documents that were deemed acceptable credentials for verifying that consumer 102 meets the ID requirements for an associated activity or event, such as a government issued badge, a pay stub issued in the last 7 days, a debit card, etc., as well as the contents of such digital ID documents. Such information may be associated with the collection of digital ID documents that were previously selected by authentication system 105 to be recommended to the verifier to complete the verification process in determining if the consumer meets the ID requirements for an associated activity or event as discussed further below.

An example of such an ID record is provided below:

```
{“case_id”: “123”,
  “provider_name”: “abc bank”,
  “provider_type”: {“bank”, “financial”},
  “client_id”: “456,”
  “client_type”: “government employee”,
  “purpose”: “open checking account”,
  “ID docs accepted”: {“government issued badge”, “pay stub issued in
last 7 days”, “debit card of a bank”}
}
```

Furthermore, in one embodiment, such ID records may include the trust level in using alternative digital ID documents in determining whether the consumer meets the ID requirements for an associated activity or event. As discussed above, in one embodiment, the “trust level” refers to the level of probability in which the alternative set of digital ID document(s) will be accepted by the verifier to replace those digital ID documents that were previously requested by the verifier but not provided by the device holder.

Additionally, in one embodiment, such ID records may include the confidence level corresponding to a confidence that the verifier has in verifying that the consumer meets the ID requirements for an associated activity or event using such an alternative set of digital ID documents.

Such information (e.g., trust level, confidence level) may be associated with the collection of digital ID documents that were previously selected by authentication system 105 to be recommended to the verifier to complete the verification process in determining if the consumer meets the ID requirements for an associated activity or event as discussed further below.

Additionally, in one embodiment, database 106 further stores the profiles of the consumers that contain information about the consumers, such as the client type (e.g., government employee). In one embodiment, such profiles are populated by the consumers upon utilizing system 100 to interact with computing device 103 of a verifier in order for the verifier to determine if such a consumer 102 meets the ID requirements for an associated activity or event.

Additionally, in one embodiment, database 106 stores the profiles of the verifiers, such as the corporate size of the verifier (e.g., national retail chain versus a local hardware store), the type of corporate entity (e.g., privately held company, government institution), the location of the verifier (e.g., local government, foreign government), etc. In one embodiment, such profiles are populated by the verifiers upon utilizing system 100 to interact with computing device 101 of consumer 102 in order for the verifier to determine if such a consumer 102 meets the ID requirements for an associated activity or event.

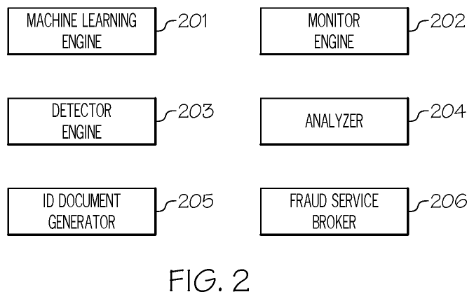

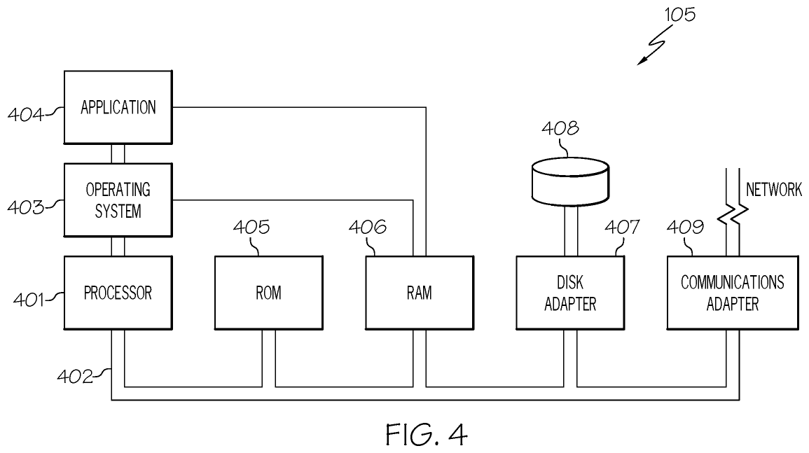

A description of the software components of authentication system 105 used for identifying alternative digital ID documents to be provided to the verifier in order to complete the verification process in determining if consumer 102 meets the ID requirements for an associated activity or event is provided below in connection with FIG. 2. A description of the hardware configuration of authentication system 105 is provided further below in connection with FIG. 4.

Furthermore, in one embodiment, authentication system 105 is configured to detect anomalous or suspicious behavior based on the pattern of digital ID documents requested and provided in the transaction involving the verifier and the consumer. In one embodiment, authentication system 105 utilizes an artificial intelligence model to generate a score corresponding to a likelihood of fraud in a transaction involving consumer 102 and the verifier. Such a model may be trained to determine the likelihood of fraud in the transaction using historical patterns of digital ID documents requested by verifiers and provided by consumers for various validation contexts corresponding to cases of fraud. “Validation context,” as used herein, refers to the circumstances that determine which ID requirements should be requested of the consumer by the verifier. For example, in order to validate the state in which consumer 102 lives, the verifier may request consumer 102 to provide a license or vehicle registration. In such an example, the validation context corresponds to validating the state in which consumer 102 lives. A further description of these and other features of authentication system 105 is provided below.

Additionally, as shown in FIG. 1, a database 107 is connected to authentication system 105, which is designed to store metadata associated with the requests from the verifiers and the responses from the consumers, such as aspects of the digital ID documents, the type of transaction (e.g., financial transaction), significance of the transaction (e.g., deed transfer), location of the consumer, etc.

Furthermore, in one embodiment, database 107 stores the historical patterns of digital ID documents requested by the verifiers and provided by the consumers for various validation contexts. Such historical patterns may be used to train an artificial intelligence model to predict a likelihood of fraud in a transaction involving the consumer and the verifier, where such a prediction may corresponds to a score (“trust score”). Based on the value of the score, a determination may be made as to whether fraud has been detected.

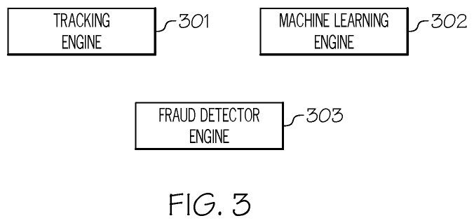

A description of the software components of authentication system 105 used to detect anomalous or suspicious behavior based on the pattern of digital ID documents requested and provided in the transaction involving the verifier and the consumer, such as consumer 102, is provided below in connection with FIGS. 2 and 3.

System 100 is not to be limited in scope to any one particular network architecture. System 100 may include any number of computing devices 101, 103, consumers 102, networks 104, authentication systems 105, and databases 106, 107. It is noted that while system 100 illustrates two separate databases (106, 107), that the information stored in such databases may be stored in a single database.

As stated above, FIG. 2 is a diagram of the software components used by authentication system 105 (FIG. 1) for identifying alternative digital ID documents to be provided to the verifier in order to complete the verification process in determining if the consumer (e.g., consumer 102) meets the ID requirements for an associated activity or event in accordance with an embodiment of the present disclosure;

Referring to FIG. 2, in conjunction with FIG. 1, authentication system 105 includes a machine learning engine 201 configured to use a machine learning algorithm (e.g., supervised learning) to build an artificial intelligence model based on sample data consisting of digital ID documents, including alternative digital ID documents, that were requested by the verifiers and provided by the consumers well as the associated type of transaction, the purpose for verifying that the consumer (e.g., consumer 102) meets the ID requirements for an associated activity or event, the trust level (e.g., level of probability in which the alternative set of digital ID document(s) will be accepted by the verifier to replace those digital ID documents that were previously requested by the verifier but not provided by the consumer) and a confidence level (confidence that the verifier has in verifying that the consumer meets the ID requirements for an associated activity or event using such an alternative set of digital ID documents). As previously discussed, such information may be stored in the ID records which are stored in database 106.

Such a data set is referred to herein as the “training data,” which is used by the machine learning algorithm to make predictions or decisions as to the appropriate alternative set of digital ID documents to be recommended to replace those digital ID documents that were requested by the verifier but not provided by the consumer. In one embodiment, the training data consists of digital ID documents, including alternative digital ID documents, that was requested by the verifier and provided by the consumer as well as the associated type of transaction, the purpose for verifying that the consumer (e.g., consumer 102) meets the ID requirements for an associated activity or event, a trust level (e.g., level of probability in which the alternative set of digital ID document(s) will be accepted by the verifier to replace those digital ID documents that were previously requested by the verifier but not provided by the consumer) and a confidence level (confidence that the verifier has in verifying that the consumer meets the ID requirements for an associated activity or event using such an alternative set of digital ID documents). The algorithm iteratively makes predictions on the training data as to the appropriate alternative set of digital ID documents to be recommended to replace those digital ID documents that were requested by the verifier but not provided by the consumer. Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict which digital ID documents should be recommended to replace those digital ID documents that were requested by the verifier but not provided by the consumer.

In one embodiment, the trust level is determined based on prior uses of such alternative digital ID documents to replace those digital ID documents that were previously requested by the verifier but not provided by the consumer. As discussed above, in one embodiment, the “trust level” refers to the level of probability in which the alternative set of digital ID document(s) will be accepted by the verifier to replace those digital ID documents that were previously requested by the verifier but not provided by the consumer. In one embodiment, such a trust level is established by machine learning engine 201 using a machine learning algorithm (e.g., supervised learning) to build a trust model based on sample data consisting of the alternative set of digital ID documents that were selected to replace those digital ID documents that were previously requested by the verifier but not provided by the consumer as well as the acceptance rate of such alternative digital ID documents by the verifier. The “acceptance rate,” as used herein, refers to the rate that such selected alternative digital ID documents were requested by the verifier to be provided by the consumer to complete the verification process in determining whether the consumer meets the ID requirements for an associated activity or event. Such a data set is referred to herein as the “training data,” which is used by the machine learning algorithm to make predictions or decisions as to the probability in which an alternative set of digital ID documents will be accepted by the verifier to replace those digital ID documents that were previously requested by the verifier but not provided by the consumer. The algorithm iteratively makes predictions on the training data as to the probability in which an alternative set of digital ID documents will be accepted by the verifier to replace those digital ID documents that were previously requested by the verifier but not provided by the consumer. Examples of such supervised learning algorithms include nearest neighbor, Naïve Bayes, decision trees, linear regression, support vector machines and neural networks.

In one embodiment, the trust model (machine learning model) corresponds to a classification model trained to predict the probability in which an alternative set of digital ID documents will be accepted by the verifier to replace those digital ID documents that were previously requested by the verifier but not provided by the consumer.

In one embodiment, the trust level is a bidirectional trust index that is based on the classification of the verifier and the consumer, such as consumer 102. Such a bidirectional trust index refers to the reliability in effectively verifying by the verifier that the consumer meets the ID requirements for an associated activity or event using the digital ID documents provided by the consumer.

In one embodiment, the classification for the verifier is based on data, such as based on the corporate size of the verifier (e.g., national retail chain versus a local hardware store), the type of corporate entity (e.g., privately held company, government institution), the location of the verifier (e.g., local government, foreign government), etc. Such information regarding the classification of the verifier may be obtained from the profile of the verifier, which is populated by the verifier upon utilizing system 100 to interact with computing device 101 of consumer 102 in order for the verifier to determine if such a consumer 102 meets the ID requirements for an associated activity or event.

Furthermore, the classification of the consumer, such as consumer 102, may be based on the geolocation data, the percentage of negotiations involving a verifier in which the consumer was deemed to be trusted, etc. In one embodiment, such geolocation data is obtained from monitor engine 202 as discussed further below. Furthermore, the percentage of negotiations involving a verifier in which the consumer was deemed to be trusted, etc. is based on historical records (e.g., ID records) stored in database 106 associated with such a consumer, which are established by detector engine 203 as discussed further below.

As discussed above, in one embodiment, the trust level is a bidirectional trust index that is based on the classification of the verifier and the consumer, such as consumer 102. For example, a verifier that is a foreign government may have a lower trust level (lower trust level index) than a local government as there may be an increased risk of the consumer not providing the requested digital ID documents to a foreign government versus a local government. In another example, a consumer that has engaged in numerous successful negotiations with the verifier (e.g., numerous successful verification processes in which the consumer was successfully verified to meet the ID requirements for an associated activity or event) may have a higher trust level (higher trust level index) than if the consumer only had a single successful verification process with the verifier.

In one embodiment, the trust model is built based on sample data consisting of the reliability in effectively verifying by the verifier that the consumer meets the ID requirements for an associated activity or event using the digital ID documents provided by the consumer based on different classifications of the consumer and the verifier. Such a data set is referred to herein as the “training data,” which is used by the machine learning algorithm to make predictions or decisions as to the trust level or the reliability in effectively verifying by the verifier that the consumer meets the ID requirements for an associated activity or event using the digital ID documents provided by the consumer based on such classifications. The algorithm (supervised learning algorithm) iteratively makes predictions on the training data as to the trust level or probability in effectively verifying by the verifier that the consumer meets the ID requirements for an associated activity or event using the digital ID documents provided by the consumer based on classifications of the consumer and the verifier. Examples of such supervised learning algorithms include nearest neighbor, Naïve Bayes, decision trees, linear regression, support vector machines and neural networks.

In one embodiment, the trust model (machine learning model) corresponds to a classification model trained to predict the trust level or probability in effectively verifying by the verifier that the consumer meets the ID requirements for an associated activity or event using the digital ID documents provided by the consumer based on the classifications of the consumer and the verifier.

In one embodiment, the “confidence level,” as used herein, refers to a confidence that the verifier has in verifying that the consumer meets the ID requirements for an associated activity or event using the alternative set of digital ID documents. In one embodiment, such a confidence level may be expressed in terms of a probability, such as a probability in successfully completing the verification process in verifying that the consumer meets the ID requirements for an associated activity or event using such alternative digital ID documents.

In one embodiment, such a confidence level is established by machine learning engine 201 using a machine learning algorithm (e.g., supervised learning) to build a confidence model based on sample data consisting of the alternative set of digital ID documents that were selected to replace those digital ID documents that were previously requested by the verifier but not provided by the consumer as well as the success rate in completing the verification process in verifying that the consumer meets the ID requirements for an associated activity or event using such alternative digital ID documents. The “success rate,” as used herein, refers to the rate that the verification process successfully verified that the consumer meets the ID requirements for an associated activity or event using such alternative digital ID documents. Such a data set is referred to herein as the “training data,” which is used by the machine learning algorithm to make predictions or decisions as to the confidence level or probability in which the verification process successfully verified that the consumer meets the ID requirements for an associated activity or event using the alternative set of digital ID documents. The algorithm iteratively makes predictions on the training data as to the confidence level or probability in which the verification process successfully verified that the consumer meets the ID requirements for an associated activity or event using the alternative set of digital ID documents. Examples of such supervised learning algorithms include nearest neighbor, Naïve Bayes, decision trees, linear regression, support vector machines and neural networks.

In one embodiment, the confidence model (machine learning model) corresponds to a classification model trained to predict the confidence level or probability in which the verification process successfully verified that the consumer meets the ID requirements for an associated activity or event using the alternative set of digital ID documents.

In one embodiment, the confidence level outputted by the confidence model corresponds to a value or score, such as a number between 0 and 1, which represents the likelihood that the verification process successfully verified that the consumer meets the ID requirements for an associated activity or event using the alternative set of digital ID documents. In one embodiment, each prediction has a confidence score. In one embodiment, the lower the confidence score, the lower the confidence that the verification process will successfully verify that the consumer meets the ID requirements for an associated activity or event using the alternative set of digital ID documents. Conversely, the higher the confidence score, the higher the confidence that the verification process will successfully verify that the consumer meets the ID requirements for an associated activity or event using the alternative set of digital ID documents.

Exemplary software tools for creating such confidence models include, but not limited to, ThingWorx® Composer, PI system®, Mosaic®, etc.

In one embodiment, the artificial intelligence model provides a listing of the alternative digital ID documents in a ranked order based on the likelihood that such alternative digital ID documents will be accepted by the verifier and the likelihood that such alternative digital ID documents will be successful in verifying that the consumer meets the ID requirements for an associated activity or event using such alternative digital ID documents. In one embodiment, such ranking is based on the trust level and the confidence level as established by the trust and confidence models discussed above. In one embodiment, the higher the ranking, the greater the likelihood that the associated alternative digital ID document will be accepted by the verifier and will be used in successfully verifying that the consumer meets the ID requirements for an associated activity or event. Conversely, the lower the ranking, the lesser the likelihood that the associated alternative digital ID document will be accepted by the verifier and will be used in successfully verifying that the consumer meets the ID requirements for an associated activity or event.

Authentication system 105 further includes a monitor engine 202 configured to monitor for the establishment of a communication connection between computing device 101 of the consumer, such as consumer 102, and computing device 103 of the verifier. Such connections may involve the establishment of a communication between such computing devices via various means, such as Bluetooth, cellular, near-field communication, etc.

Such monitoring may be accomplished by monitor engine 202 using various software tools, including, but not limited to, SolarWinds® Server & Application Monitor, Datadog®, Zabbix®, Dynatrace®, LogicMonitor®, Sumo Logic®, etc.

In one embodiment, such monitoring may include obtaining the geolocation information of computing device 101 of consumer 102 and the geolocation information of computing device 103 of the verifier. A “geolocation,” as used herein, refers to the geographical (latitudinal and longitudinal) location of a network connected device. In one embodiment, such geolocation information is obtained by monitor engine 202 via a geolocation API which requests permission from the browser of computing devices 101, 103 to access their location data. In one embodiment, such geolocation information forms part of the consumer's response to the verifier's request for providing the digital ID documents.

Authentication system 105 additionally includes a detector engine 203 configured to detect a request for a set of digital ID documents to be provided by computing device 101 of consumer 102 to computing device 103 of the verifier. Furthermore, detector engine 203 is configured to detect a response to such a request by computing device 101 of device 102.

Such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In one embodiment, detector engine 203 is configured to determine the type of transaction involved in the communication between the verifier and consumer 102 based on reviewing the profile of consumer 102 stored in database 106 that contains information about the consumer, such as the client type (e.g., government employee). In one embodiment, such a profile was populated by consumer 102 upon utilizing system 100 to interact with computing device 103 of the verifier in order for the verifier to determine if consumer 102 meets the ID requirements for an associated activity or event. In one embodiment, the transaction type is identified in the profile associated with the consumer in question using natural language processing in which keywords, such as “transaction type” or “client type,” in the profile are identified thereby enabling detector engine 203 to determine the type of transaction based on the word(s) following such keywords in the profile. In one embodiment, such information is used to populate an ID record associated with the consumer involved in such a communication.

In one embodiment, detector engine 203 is configured to determine the purpose for verifying that the consumer (e.g., consumer 102) meets the ID requirements for an associated activity or event based on the activity or event mentioned in the request provided by the verifier to the consumer, such as consumer 102. In one embodiment, detector engine 203 uses natural language processing to identify such activities or events. In one embodiment, a data structure (e.g., table) contains a listing of keywords (e.g., “opening checking account”) associated with various activities or events. In one embodiment, such a data structure is populated by an expert. In one embodiment, detector engine 203 analyzes the request issued by the verifier to identify such keywords listed in the data structure using natural language processing thereby identifying the purpose for verifying that the consumer (e.g., consumer 102) meets the ID requirements for an associated activity or event. In one embodiment, such information is used to populate an ID record associated with the consumer involved in such a communication.

Furthermore, authentication system 105 includes an analyzer 204 configured to determine whether there has been any previously established trust relationship between the verifier (e.g., Home Depot®) or a related third party (e.g., Lowes®) and consumer 102 upon detector engine 203 detecting a request issued by the verifier to consumer 102 to provide a set of digital ID documents to the verifier.

In one embodiment, previously established trust relationships between verifiers and consumers are stored in database 106, such as in a data structure (e.g., table). A “trust relationship,” as used herein, refers to a secure communication channel between computing device 103 of a verifier and computing device 101 of a consumer, such as consumer 102, in which the sending of digital ID documents (requested by the verifier) to the verifier by the consumer, such as consumer 102, is permitted to occur. In one embodiment, such trust relationships may be detected by detector engine 203 based on detecting the requests and responses between the verifier and the consumer. Such information may be populated in a data structure (e.g., table) that includes a listing of verifiers with established trust relationships with various consumers. In one embodiment, such a data structure resides in a storage device (e.g., memory, disk unit) of authentication system 105.

Furthermore, in one embodiment, verifiers may be cross-referenced with other verifiers in the data structure that are related, such as by industry. For example, the verifier of Home Depot® may be deemed to be related to the verifier of Lowes® since both merchants are in the home improvement service. In one embodiment, such cross-referencing is populated in the data structure by an expert. In one embodiment, such cross-referencing is stored in a list maintained in the data structure discussed above or in a separate data structure (e.g., table). Such a separate data structure may also be stored in a storage device (e.g., memory, disk unit) of authentication system 105. As a result, if a consumer has a trust relationship with Home Depot®, then such a trust relationship may be deemed to be valid with Lowes® even though the consumer may not have previously provided digital ID documents to such a merchant.

In one embodiment, upon detector engine 203 detecting a request issued by the verifier to consumer 102 to provide a set of digital ID documents to the verifier, analyzer 204 is configured to search in the data structure discussed above for a matching pair of the verifier (or related verifier) and consumer involved in the detected request. For example, if the request involves the verifier of Home Depot® and the consumer, then analyzer 204 is configured to search in the data structure for a matching pair of the verifiers Home Depot® or Lowes® (related verifier) and the consumer.

If such a matching pair is identified in the data structure, then analyzer 204 is configured to inform the verifier of a previously established trust relationship between the verifier (or a related third party verifier) and the consumer thereby recommending that a subset of the digital ID documents are not required. In one embodiment, such a recommended set of digital ID documents corresponds to those digital ID documents that were previously provided by the consumer to the verifier (or a related third party verifier) as indicated in the ID records of database 106. For example, the identifications of the particular digital ID documents that were provided by the consumer to the verifier (or related third party verifier) may have been previously stored in the ID record associated with such a validation process.

Furthermore, in one embodiment, after detector engine 203 detects a response by computing device 101 of device 102 to the request to provide a set of digital ID documents issued by the verifier, analyzer 204 is configured to determine if the response provides a subset of the digital ID documents requested by the verifier. For example, the verifier may have requested the digital ID documents of a government issued badge and a pay stub issued in the last 7 days. However, consumer 102 may have only provided a government issued badge.

In one embodiment, such a determination is performed by analyzer 204 utilizing natural language processing to identify a list of digital ID documents requested by the verifier for consumer 102 to provide and to identify which digital ID documents from the list of digital ID documents were actually provided by consumer 102 in the response.

In one embodiment, a possible list of digital ID documents to be requested by the verifier and provided by the consumer is listed in a data structure (e.g., table). In one embodiment, such a data structure is populated by an expert. In one embodiment, analyzer 204 is configured to identify a digital ID document requested by the verifier in the request issued by the verifier by matching a term in the request with one of the keywords in the data structure that identifies a digital ID document using natural language processing. Furthermore, in one embodiment, analyzer 204 is configured to identify a digital ID document in the response issued by the consumer, such as consumer 102, by matching a term in the response with one of the keywords in the data structure that identifies a digital ID document using natural language processing. By comparing such digital ID documents identified in the request and response, analyzer 204 determines which, if any, of the digital ID documents that were requested by the verifier were not provided by the consumer. In one embodiment, such a data structure is stored in the storage device (e.g., memory, disk unit) of authentication system 105.

If analyzer 204 determines that a subset of the digital ID documents that were requested by the verifier were not provided by consumer 102, including identifying which particular digital ID documents were not provided by consumer 102, then ID document generator 205 of authentication system 105 determines if there are any alternative digital ID documents to provide to the verifier to replace those digital ID documents that were requested by the verifier but not provided by consumer 102.

In one embodiment, a data structure (e.g., table) may be populated with a listing of digital ID documents as well as a listing of digital ID documents that could be provided as a substitute for such digital ID documents. In one embodiment, such a data structure is populated by an expert. In one embodiment, such a data structure resides within the storage device (e.g., memory, disk unit) of authentication system 105.

In one embodiment, after determining by analyzer 204 as to which digital ID documents were not provided by consumer 102 as requested by the verifier, ID document generator 205 is configured to search and identify such digital ID documents in the data structure listed above using natural language processing to determine if there any alternative digital ID documents that could be provided as a substitute for such digital ID documents. For example, the data structure may include an entry of the digital ID document of a pay stub for the last 7 days as well as an entry for a debit card of a bank as a substitute for a pay stub for the last 7 days.

In one embodiment, ID document generator 205 identifies alternative digital ID documents, if any, based on inquiring the artificial intelligence model built by machine learning engine 201 to identify alternative digital ID documents to replace those digital ID documents that were requested by the verifier but not provided by consumer 102. In one embodiment, ID document generator 205 inputs various information to the model, such as the digital ID documents that were not provided by consumer 102 as requested by the verifier, the type of transaction (e.g., government employee) and/or the purpose for verifying that the consumer (e.g., consumer 102) meets the ID requirements for an associated activity or event. The listing of the digital ID documents that were not provided by consumer 102 is obtained by analyzer 204. The type of transaction and the purpose may be obtained via the ID record associated with such a communication, which may be populated by detector engine 203 as discussed above.

As discussed above, such information may be used by the artificial intelligence model to identify such alternative digital ID documents. Furthermore, as discussed above, the artificial intelligence model may use the trust level obtained from the trust model and the confidence level obtained from the confidence model to identify such alternative digital ID documents as discussed above.

If there were no alternative digital ID documents that were identified by the model, then ID document generator 205 informs the verifier that alternative digital ID documents are not available. If, however, there are alternative digital ID documents available, then ID document generator 205 may instruct computing device 103 of the verifier to complete the verification process by using one or more of such alternative digital ID documents.

Authentication system 105 further includes a fraud service broker 206 configured to detect anomalous or suspicious behavior based on the pattern of digital ID documents requested and provided in the transaction involving the verifier and the consumer, such as consumer 102. A discussion regarding the software sub-components of fraud service broker 206 is provided below in connection with FIG. 3.

Referring now to FIG. 3, FIG. 3 is a diagram of the software components used by fraud service broker 206 (FIG. 2) for detecting anomalous or suspicious behavior based on patterns of digital ID documents in accordance with an embodiment of the present disclosure.

Referring to FIG. 3, in conjunction with FIGS. 1-2, fraud service broker 206 includes a tracking engine 301 for tracking the identifications of the digital ID documents being requested by the verifier to be provided by consumer 102, and the identifications of the digital ID documents being provided by consumer 102 to the verifier. In one embodiment, a list of possible digital ID documents to be requested by the verifier as well as a list of possible digital ID documents to be provided by the consumer are stored in a data structure (e.g., table). In one embodiment, such a data structure is populated by an expert. In one embodiment, tracking engine 301 is configured to identify an identification of a digital ID document in the request or response by matching a term in the request or response with one of the keywords in the data structure that identifies a digital ID document using natural language processing. In one embodiment, such a data structure is stored in the storage device (e.g., memory, disk unit) of authentication system 105.

Furthermore, in one embodiment, tracking engine 301 analyzes the metadata associated with the request from the verifier and the response from the consumer, such as consumer 102, to determine the schema of the digital ID documents and the context values. “Schema,” as used herein, refers to the structural representation of the digital ID documents, such as the validation context, the type of transaction, the significance of the transaction, the location of the consumer, etc. The “context values,” as used herein, refer to the values of such representation elements. For example, the context value for the validation context (refers to the circumstances that determine which ID requirements should be requested of the consumer by the verifier) may correspond to requesting the age of the consumer to rent a car. In another example, the context value for the type of transaction may correspond to a financial transaction. In a further example, the context value for the significance of the transaction may correspond to a deed transfer. In another example, the context value for the location of the consumer may correspond to the state of Texas. In one embodiment, such metadata is contained in the header of the request or response. In one embodiment, such metadata is contained in a specialist document or a database 107 designed to store such metadata, such as a data dictionary or a metadata repository.

In one embodiment, the identification and analysis of metadata may be accomplished by tracking engine 301 using various software tools, including, but not limited to, IBM Watson® Knowledge Catalog, Oracle Enterprise® Data Management, Azure Data Catalog, Adaptive Metadata Manager, Unifi® Data Catalog, Informatica® Enterprise Data Catalog, etc.

In one embodiment, the identifications of the digital ID documents in the requests and responses and the metadata associated with such requests and responses as obtained by tracking engine 301 may be used to form the historical patterns of digital ID documents requested by the verifiers and provided by the consumers for various validation contexts. Furthermore, such historical patterns may include other information from the metadata, such as the type of transaction, the significance of the transaction, location of the consumer, etc. In one embodiment, such historical patterns are analyzed by an expert to identify cases of fraud. Such historical patterns may then be used to train an artificial intelligence model to predict a likelihood of fraud in a transaction involving the consumer, such as consumer 102, and a verifier, where such a prediction may corresponds to a score (“trust score”). Based on the value of the score, a determination may be made as to whether fraud has been detected. In one embodiment, such historical patterns of digital ID documents are stored in database 107.

Furthermore, in one embodiment, fraud service broker 206 includes a machine learning engine 302 configured to use a machine learning algorithm (e.g., supervised learning) to build an artificial intelligence model based on sample data consisting of historical patterns of digital ID documents requested by verifiers and provided by consumers for various validation contexts corresponding to cases of fraud. Such a data set is referred to herein as the “training data,” which is used by the machine learning algorithm to make predictions or decisions as to the likelihood of fraud in a transaction involving the consumer and the verifier based on the validation contexts, the digital ID documents requested by the verifier and the digital ID documents provided by the consumer. The algorithm iteratively makes predictions on the training data as to the appropriate prediction of the likelihood of fraud in a transaction, which may be represented as a score (“trust score”). Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict the likelihood of fraud in a transaction between the verifier and the consumer.

In one embodiment, such a model (artificial intelligence model) only utilizes the metadata associated with such requests and responses as opposed to the credentials or the information within such digital ID documents, which may be confidential, that were provided by the consumer.

In one embodiment, the artificial intelligence model built by machine learning engine 302 determines whether the transaction between the verifier and the consumer involves fraud based on matching the pattern in such a transaction with a previous pattern deemed to be a fraudulent transaction. In one embodiment, the artificial intelligence model detects the pattern of over or under sharing information based on the context of the transaction. In one embodiment, the artificial intelligence model detects the pattern of the consumer using inconsistent credentials, such as providing one digital ID documents that proves one aspect and then providing another digital ID document that proves the opposite. For example, the consumer may provide a digital ID document that proves that the consumer is a homeowner and then provides another digital ID document that proves that the consumer is a renter.

In one embodiment, feedback is provided to the artificial intelligence model as to the accuracy of its output (“trust score”) in representing the likelihood of fraud in the transaction.

Such feedback may be used by the model to improve its accuracy. In one embodiment, such feedback is used by a variance model to add or subtract a value from the trust score outputted by the artificial intelligence model.

In one embodiment, the variance model is used to dynamically adjust the trust score (raise or lower the score) of the artificial intelligence model based on various factors, such as the patterns of digital ID documents (e.g., order of the digital ID documents presented to the verifier from the consumer), variance in the digital ID documents requested by the verifier and provided by the consumer, discrepancies found in the digital ID documents provided by the consumer, inconsistencies found in the digital ID documents provided by the consumer, inconsistences between the transaction assumptions and the presented digital ID documents, etc. For example, based on the validation context to provide evidence of residence in the state of Texas, it would be assumed that the consumer presents a digital ID document from the state of Texas as opposed to presenting a digital ID document from another state.

Fraud service broker 206 additionally includes a fraud detector engine 303 configured to inform computing device 103 of the verifier that there is evidence of fraud based on the value of the trust score generated by the artificial intelligence model discussed above. For example, if the value of the trust score does not meet or exceed a threshold value, which may be user-selected, then fraud detector engine 303 informs computing device 103 of the verifier, such as via email, instant messaging, etc., that there is evidence of fraud and to proceed with not accepting the alternative ID documents provided by the consumer, such as consumer 102. Alternatively, if the value of the trust score meets or exceeds a threshold value, which may be user-selected, then fraud detector engine 303 informs computing device 103 of the verifier, such as via email, instant messaging, etc., that there is no evidence of fraud and to proceed with accepting the alternative ID documents provided by the consumer, such as consumer 102.

Fraud detector engine 303 performs such features using various software tools, including, but not limited to, Dynatrace®, Alteryx® Analytic Process Automation Platform™ IBM® Cognos Analytics, Sisense Fusion® Analytics, etc.

A further description of these and other functions is provided below in connection with the discussion of the method for identifying suspicious behavior based on the pattern of digital ID documents requested and provided in the transaction involving the verifier and the consumer in accordance with an embodiment of the present disclosure

Prior to the discussion of the method for identifying suspicious behavior based on the pattern of digital ID documents requested and provided in the transaction involving the verifier and the consumer, a description of the hardware configuration of authentication system 105 is provided below in connection with FIG. 4.

Referring now to FIG. 4, FIG. 4 illustrates an embodiment of the present disclosure of the hardware configuration of an authentication system 105 (FIG. 1) which is representative of a hardware environment for practicing the present disclosure.

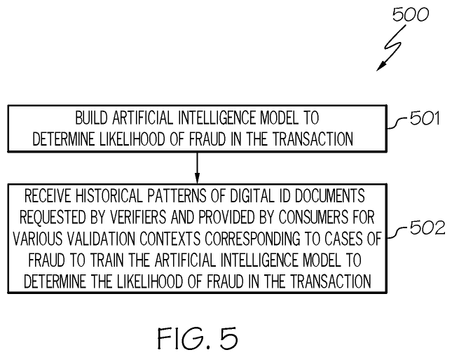

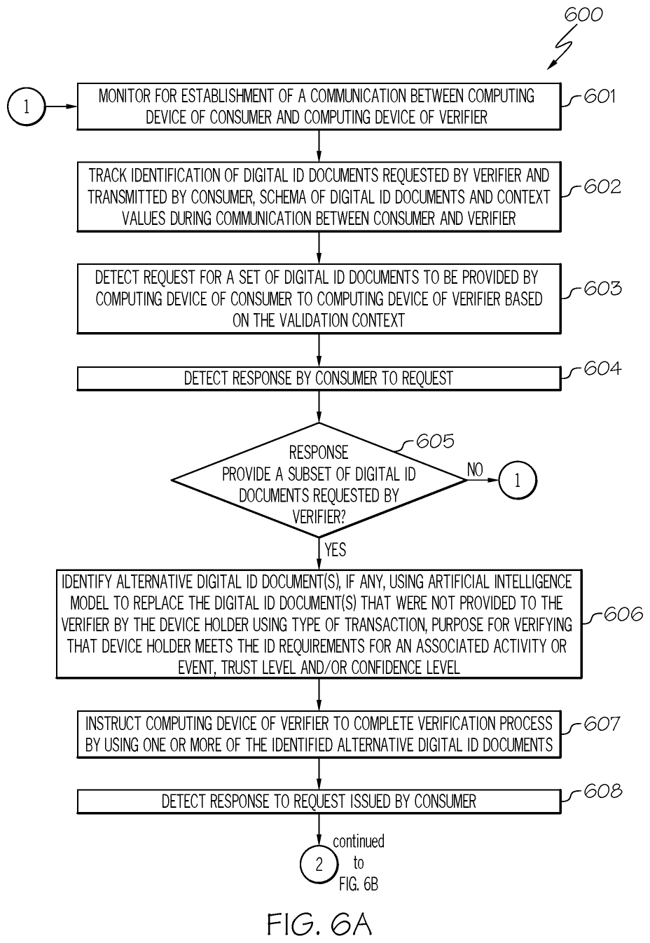

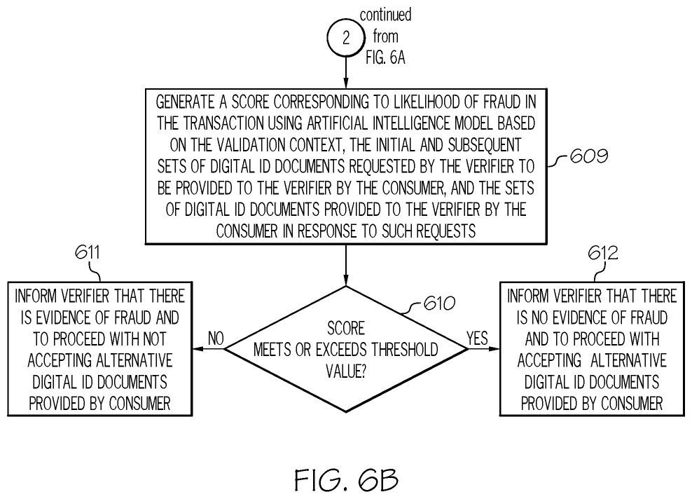

Authentication system 105 has a processor 401 connected to various other components by system bus 402. An operating system 403 runs on processor 401 and provides control and coordinates the functions of the various components of FIG. 4. An application 404 in accordance with the principles of the present disclosure runs in conjunction with operating system 403 and provides calls to operating system 403 where the calls implement the various functions or services to be performed by application 404. Application 404 may include, for example, machine learning engine 201 (FIG. 2), monitor engine 202 (FIG. 2), detector engine 203 (FIG. 2), analyzer 204 (FIG. 2), ID document generator 205 (FIG. 2), fraud service broker 206 (FIG. 2), tracking engine 301 (FIG. 3), machine learning engine 302 (FIG. 3) and fraud detector engine 303 (FIG. 3). Furthermore, application 404 may include, for example, a program for verifying that a user meets the ID requirements for an associated activity or event using an alternative set of digital ID documents than previously requested by the verifier as discussed further below in connection with FIGS. 6A-6B. Additionally, application 404 may include, for example, a program for identifying suspicious behavior based on the pattern of digital ID documents requested and provided in the transaction involving the verifier and the consumer as discussed further below in connection with FIGS. 5 and 6A-6B.

Referring again to FIG. 4, read-only memory (“ROM”) 405 is connected to system bus 402 and includes a basic input/output system (“BIOS”) that controls certain basic functions of authentication system 105. Random access memory (“RAM”) 406 and disk adapter 407 are also connected to system bus 402. It should be noted that software components including operating system 403 and application 404 may be loaded into RAM 406, which may be authentication system's 105 main memory for execution. Disk adapter 407 may be an integrated drive electronics (“IDE”) adapter that communicates with a disk unit 408, e.g., disk drive. It is noted that the program for verifying that a user meets the ID requirements for an associated activity or event using an alternative set of digital ID documents than previously requested by the verifier, as discussed further below in connection with FIGS. 6A-6B, may reside in disk unit 408 or in application 404. It is further noted that the program for identifying suspicious behavior based on the pattern of digital ID documents requested and provided in the transaction involving the verifier and the consumer, as discussed further below in connection with FIGS. 5 and 6A-6B, may reside in disk unit 408 or in application 404.

Authentication system 105 may further include a communications adapter 409 connected to bus 402. Communications adapter 409 interconnects bus 402 with an outside network (e.g., network 104) to communicate with other devices, such as computing devices 101, 103.

In one embodiment, application 404 includes the software components of machine learning engine 201, monitor engine 202, detector engine 203, analyzer 204, ID document generator 205, fraud service broker 206, tracking engine 301, machine learning engine 302 and fraud detector engine 303. In one embodiment, such components may be implemented in hardware, where such hardware components would be connected to bus 402. The functions discussed above performed by such components are not generic computer functions. As a result, authentication system 105 is a particular machine that is the result of implementing specific, non-generic computer functions.

In one embodiment, the functionality of such software components (e.g., machine learning engine 201, monitor engine 202, detector engine 203, analyzer 204, ID document generator 205, fraud service broker 206, tracking engine 301, machine learning engine 302 and fraud detector engine 303) of authentication system 105, including the functionality for verifying that a user meets the ID requirements for an associated activity or event using an alternative set of digital ID documents than previously requested by the verifier as well as the functionality for identifying suspicious behavior based on patterns of digital ID documents, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, fraud detection is a set of processes and analyses that allow organizations to identify and prevent unauthorized activities. Such unauthorized activities may include fraudulent credit card transactions, identity theft, cyber hacking, insurance scams, and more. With an unlimited and rising number of ways someone can commit fraud, detection can be difficult. Activities, such as reorganization, moving to new information systems or encountering a cybersecurity breach could weaken an organization's ability to detect fraud. Techniques, such as real-time monitoring for fraud is generally recommended. Fraud detection systems typically search for patterns or anomalies of suspicious behavior as a general focus for fraud detection. Such patterns and anomalies of suspicious behavior are detected based on current data or device use patterns. For example, data analysts may attempt to prevent insurance fraud by creating algorithms to detect patterns and anomalies of suspicious behavior based on current data or device use patterns. Unfortunately, by simply detecting patterns and anomalies of suspicious behavior based on current data or device use patterns, many fraudulent activities will not be detected.

The embodiments of the present disclosure provide a means for detecting suspicious behavior based on patterns of digital ID documents, such as digital ID documents requested by the verifier and provided by the consumer, as discussed below in connection with FIGS. 5 and 6A-6B. FIG. 5 is a flowchart of a method for creating an artificial intelligence model to generate a score corresponding to a likelihood of fraud in a transaction involving the consumer and the verifier. FIGS. 6A-6B are a flowchart of a method for detecting suspicious behavior based on the pattern of digital ID documents requested and provided in the transaction involving the verifier and the consumer.

As stated above, FIG. 5 is a flowchart of a method 500 for creating an artificial intelligence model to generate a score corresponding to a likelihood of fraud in a transaction involving the consumer and the verifier in accordance with an embodiment of the present disclosure.

Referring to FIG. 5, in conjunction with FIGS. 1-4, in step 501, machine learning engine 302 of fraud service broker 206 of authentication system 105 builds an artificial intelligence model to determine the likelihood of fraud in the transaction between the consumer and the verifier.

In step 502, machine learning engine 302 of fraud service broker 206 of authentication system 105 receives historical patterns of digital ID documents requested by verifiers and provided by consumers for various validation contexts corresponding to cases of fraud to train the artificial intelligence model to determine the likelihood of fraud in the transaction involving the consumer, such as consumer 102, and the verifier. That is, machine learning engine 302 receives the validation context, the identification of the digital ID documents requested by the verifier to be provided by the consumer, the identification of the digital ID documents provided by the consumer to the verifier and the identification of those transactions deemed to be fraudulent to train the artificial intelligence model to determine the likelihood of fraud in the transaction involving the verifier and the consumer, such as consumer 102.

As discussed above, in one embodiment, machine learning engine 302 uses a machine learning algorithm (e.g., supervised learning) to build an artificial intelligence model based on sample data consisting of historical patterns of digital ID documents requested by verifiers and provided by consumers for various validation contexts corresponding to cases of fraud. Such a data set is referred to herein as the “training data,” which is used by the machine learning algorithm to make predictions or decisions as to the likelihood of fraud in a transaction involving the consumer and the verifier based on the validation contexts, the digital ID documents requested by the verifier and the digital ID documents provided by the consumer. The algorithm iteratively makes predictions on the training data as to the appropriate prediction of the likelihood of fraud in a transaction, which may be represented as a score (“trust score”). Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict the likelihood of fraud in a transaction between the verifier and the consumer.

In one embodiment, such a model (artificial intelligence model) only utilizes the metadata associated with such requests and responses as opposed to the credentials or the information within such digital ID documents, which may be confidential, that were provided by the consumer.

In one embodiment, the artificial intelligence model built by machine learning engine 302 determines whether the transaction between the verifier and the consumer involves fraud based on matching the pattern in such a transaction with a previous pattern deemed to be a fraudulent transaction. In one embodiment, the artificial intelligence model detects the pattern of over or under sharing information based on the context of the transaction. In one embodiment, the artificial intelligence model detects the pattern of the consumer using inconsistent credentials, such as providing one digital ID documents that proves one aspect and then providing another digital ID document that proves the opposite. For example, the consumer may provide a digital ID document that proves that the consumer is a homeowner and then provides another digital ID document that proves that the consumer is a renter.

In one embodiment, feedback is provided to the artificial intelligence model as to the accuracy of its output (“trust score”) in representing the likelihood of fraud in the transaction. Such feedback may be used by the model to improve its accuracy. In one embodiment, such feedback is used by a variance model to add or subtract a value from the trust score outputted by the artificial intelligence model.

In one embodiment, the variance model is used to dynamically adjust the trust score (raise or lower the score) of the artificial intelligence model based on various factors, such as the patterns of digital ID documents (e.g., order of the digital ID documents presented to the verifier from the consumer), variance in the digital ID documents requested by the verifier and provided by the consumer, discrepancies found in the digital ID documents provided by the consumer, inconsistencies found in the digital ID documents provided by the consumer, inconsistences between the transaction assumptions and the presented digital ID documents, etc. For example, based on the validation context to provide evidence of residence in the state of Texas, it would be assumed that the consumer presents a digital ID document from the state of Texas as opposed to presenting a digital ID document from another state.

After building the artificial intelligence model, such a model is used to determine the likelihood of fraud in the transaction between the consumer, such as consumer 102, and the verifier, based on the types of digital ID documents requested by the verifier and shared with the verifier by the consumer given the context of the transaction as discussed below in connection with FIGS. 6A-6B.

FIGS. 6A-6B are a flowchart of a method 600 for detecting suspicious behavior based on the pattern of digital ID documents requested and provided in the transaction involving the verifier and the consumer in accordance with an embodiment of the present disclosure.

Referring to FIG. 6A, in conjunction with FIGS. 1-5, in step 601, monitor engine 202 of authentication system 105 monitors for the establishment of a communication between computing device 101 of consumer 102 and computing device 103 of the verifier.

As stated above, such connections may involve the establishment of a communication between such computing devices via various means, such as Bluetooth, cellular, near-field communication, etc.

Such monitoring may be accomplished by monitor engine 202 using various software tools, including, but not limited to, SolarWinds® Server & Application Monitor, Datadog®, Zabbix®, Dynatrace®, LogicMonitor®, Sumo Logic®, etc.

In step 602, tracking engine 301 of fraud service broker 206 of authentication system 105 tracks the identification of digital ID documents requested by the verifier and transmitted by the consumer, the schema of digital ID documents and the context values during the communication between the consumer and the verifier.

As discussed above, in one embodiment, tracking engine 301 tracks the identifications of the digital ID documents being requested by the verifier to be provided by consumer 102, and the identifications of the digital ID documents being provided by consumer 102 to the verifier. In one embodiment, a list of possible digital ID documents to be requested by the verifier as well as a list of possible digital ID documents to be provided by the consumer are stored in a data structure (e.g., table). In one embodiment, such a data structure is populated by an expert. In one embodiment, tracking engine 301 is configured to identify an identification of a digital ID document in the request or response by matching a term in the request or response with one of the keywords in the data structure that identifies a digital ID document using natural language processing. In one embodiment, such a data structure is stored in the storage device (e.g., memory 405, disk unit 408) of authentication system 105.

Furthermore, in one embodiment, tracking engine 301 analyzes the metadata associated with the request from the verifier and the response from the consumer, such as consumer 102, to determine the schema of the digital ID documents and the context values. “Schema,” as used herein, refers to the structural representation of the digital ID documents, such as the validation context, the type of transaction, the significance of the transaction, the location of the consumer, etc. The “context values,” as used herein, refer to the values of such representation elements. For example, the context value for the validation context (refers to the circumstances that determine which ID requirements should be requested of the consumer by the verifier) may correspond to requesting the age of the consumer to rent a car. In another example, the context value for the type of transaction may correspond to a financial transaction. In a further example, the context value for the significance of the transaction may correspond to a deed transfer. In another example, the context value for the location of the consumer may correspond to the state of Texas. In one embodiment, such metadata is contained in the header of the request or response. In one embodiment, such metadata is contained in a specialist document or a database 107 designed to store such metadata, such as a data dictionary or a metadata repository.

In one embodiment, the identification and analysis of metadata may be accomplished by tracking engine 301 using various software tools, including, but not limited to, IBM Watson® Knowledge Catalog, Oracle Enterprise® Data Management, Azure Data Catalog, Adaptive Metadata Manager, Unifi® Data Catalog, Informatica® Enterprise Data Catalog, etc.

In one embodiment, the identifications of the digital ID documents in the requests and responses and the metadata associated with such requests and responses as obtained by tracking engine 301 may be used to form the historical patterns of digital ID documents requested by the verifiers and provided by the consumers for various validation contexts. Furthermore, such historical patterns may include other information from the metadata, such as the type of transaction, the significance of the transaction, location of the consumer, etc. In one embodiment, such historical patterns are analyzed by an expert to identify cases of fraud. Such historical patterns may then be used to train an artificial intelligence model to predict a likelihood of fraud in a transaction involving the consumer, such as consumer 102, and a verifier, where such a prediction may corresponds to a score (“trust score”). Based on the value of the score, a determination may be made as to whether fraud has been detected. In one embodiment, such historical patterns of digital ID documents are stored in database 107.

In step 603, detector engine 203 of authentication system 105 detects the request from computing device 103 of the verifier for a set of digital ID documents (e.g., pay stub in last 30 days) to be provided to computing device 103 of the verifier by computing device 101 of the device holder, such as consumer 102, based on the validation context in order to verify that the consumer meets the ID requirements for the associated activity or event.

As discussed above, such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In step 604, detector engine 203 of authentication system 105 detects a response by computing device 101 of consumer 102 to the request to provide a set of digital ID documents issued by the verifier.

As discussed above, such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In step 605, analyzer 204 of authentication system 105 determines whether the response provided a subset of the digital ID documents requested by the verifier. For example, the verifier may have requested the digital ID documents of a government issued badge and a pay stub issued in the last 7 days. However, consumer 102 may have only provided a government issued badge.

As discussed above, in one embodiment, such a determination is performed by analyzer 204 utilizing natural language processing to identify a list of digital ID documents requested by the verifier for consumer 102 to provide and to identify which digital ID documents from the list of digital ID documents were actually provided by consumer 102 in the response.

In one embodiment, a possible list of digital ID documents to be requested by the verifier and provided by the consumer is listed in a data structure (e.g., table). In one embodiment, such a data structure is populated by an expert. In one embodiment, analyzer 204 is configured to identify a digital ID document requested by the verifier in the request issued by the verifier by matching a term in the request with one of the keywords in the data structure that identifies a digital ID document using natural language processing. Furthermore, in one embodiment, analyzer 204 is configured to identify a digital ID document in the response issued by the consumer, such as consumer 102, by matching a term in the response with one of the keywords in the data structure that identifies a digital ID document using natural language processing. By comparing such digital ID documents identified in the request and response, analyzer 204 determines which, if any, of the digital ID documents that were requested by the verifier were not provided by the consumer. In one embodiment, such a data structure is stored in the storage device (e.g., memory 405, disk unit 408) of authentication system 105.

If analyzer 204 determines that all of the requested digital ID documents were provided by consumer 102, then monitor engine 202 of authentication system 105 continues to monitor for the establishment of a communication between computing device 101 of a consumer and computing device 103 of the verifier in step 601.

If, however, analyzer 204 determines that a subset of the digital ID documents that were requested by the verifier were not provided by consumer 102, including identifying which particular digital ID documents were not provided by consumer 102, then, in step 606, ID document generator 205 of authentication system 105 identifies alternative digital ID document(s), if any, using the artificial intelligence model to replace the digital ID document(s) that were not provided to the verifier by the consumer using the transaction type, the purpose for verifying that the consumer meets the ID requirements for an associated activity or event, the trust level and/or the confidence level.

As stated above, in one embodiment, detector engine 203 is configured to determine the type of transaction involved in the communication between the verifier and consumer 102 based on reviewing the profile of consumer 102 stored in database 106 that contains information about the consumer, such as the client type (e.g., government employee). In one embodiment, such a profile was populated by consumer 102 upon utilizing system 100 to interact with computing device 103 of the verifier in order for the verifier to determine if consumer 102 meets the ID requirements for an associated activity or event. In one embodiment, the transaction type is identified in the profile associated with the consumer in question using natural language processing in which keywords, such as “transaction type” or “client type,” in the profile are identified thereby enabling detector engine 203 to determine the type of transaction based on the word(s) following such keywords in the profile. In one embodiment, such information is used to populate an ID record associated with the consumer involved in such a communication.

In one embodiment, detector engine 203 is configured to determine the purpose for verifying that the consumer (e.g., consumer 102) meets the ID requirements for an associated activity or event based on the activity or event mentioned in the request provided by the verifier to the consumer, such as consumer 102. In one embodiment, detector engine 203 uses natural language processing to identify such activities or events. In one embodiment, a data structure (e.g., table) contains a listing of keywords (e.g., “opening checking account”) associated with various activities or events. In one embodiment, such a data structure is populated by an expert. In one embodiment, detector engine 203 analyzes the request issued by the verifier to identify such keywords listed in the data structure using natural language processing thereby identifying the purpose for verifying that the consumer (e.g., consumer 102) meets the ID requirements for an associated activity or event. In one embodiment, such information is used to populate an ID record associated with the consumer involved in such a communication.

As discussed above, in one embodiment, ID document generator 205 inputs various information to the artificial intelligence model, such as the digital ID documents that were not provided by consumer 102 as requested by the verifier, the type of transaction (e.g., government employee) and/or the purpose for verifying that the consumer (e.g., consumer 102) meets the ID requirements for an associated activity or event. The listing of the digital ID documents that were not provided by consumer 102 is obtained by analyzer 204. The type of transaction and the purpose may be obtained via the ID record associated with such a communication, which may be populated by detector engine 203 as discussed above.

As stated above, such information may be used by the artificial intelligence model to identify such alternative digital ID documents. Furthermore, as discussed above, the artificial intelligence model may use the trust level obtained from the trust model and the confidence level obtained from the confidence model to identify such alternative digital ID documents as discussed above.

In step 607, ID document generator 205 of authentication system 105 instructs computing device 103 of the verifier to complete the verification process by using one or more of such alternative digital ID documents. That is, ID document generator 205 instructs computing device 103 of the verifier to complete the verification of the consumer meeting the ID requirements for the associated activity or event by requesting one or more of the alternative digital ID documents from computing device 101 of consumer 102.

As discussed above, in one embodiment, the alternative digital ID documents provided by the artificial intelligence model are provided in a ranked order based on the likelihood that such alternative digital ID documents will be accepted by the verifier and the likelihood that such alternative digital ID documents will be successful in verifying that the consumer meets the ID requirements for an associated activity or event using such alternative digital ID documents. In one embodiment, such ranking is based on the trust level and the confidence level as established by the trust and confidence models discussed above. In one embodiment, the higher the ranking, the greater the likelihood that the associated alternative digital ID document will be accepted by the verifier and will be successful in verifying that the consumer meets the ID requirements for an associated activity or event using such alternative digital ID documents. Conversely, the lower the ranking, the lesser the likelihood that the associated alternative digital ID document will be accepted by the verifier and will be successful in verifying that the consumer meets the ID requirements for an associated activity or event using such alternative digital ID documents.

Upon receipt of the instruction from authentication system 105, computing device 103 of the verifier issues a request to computing device 101 of consumer 102 to provide one or more of the identified alternative digital ID documents to the verifier. In one embodiment, the verifier decides which of the alternative digital ID documents provided by ID document generator 205 to use to complete the verification process in verifying that consumer 102 meets the ID requirements (e.g., licensed for activity, age) for an associated activity or event. Such a selection may be reflected in a subsequent request that is issued to consumer 102 which includes a new listing of digital ID documents for consumer 102 to provide in order to compete the verification process. Such a new listing of digital ID documents includes the alternative digital ID documents recommended by ID document generator 205 to be requested by the verifier to complete the verification process.

After computing device 103 of the verifier issues such a request, in step 608, detector engine 203 of authentication system 105 detects a response by computing device 101 of consumer 102 to the request to provide digital ID document(s) to the verifier.

Referring now to FIG. 6B, in conjunction with FIGS. 1-5, in step 609, machine learning engine 302 of fraud service broker 206 of authentication system 105 generates a score (“trust score”) corresponding to the likelihood of fraud in the transaction involving the consumer (e.g., consumer 102) and the verifier using the artificial intelligence model (built in method 400) based on the validation context, the initial and subsequent sets of digital ID documents requested by the verifier to be provided to the verifier by the consumer, and the sets of digital ID documents provided by the consumer to the verifier in response to such requests.

As discussed above, the artificial intelligence model is built and trained to make predictions or decisions as to the likelihood of fraud in a transaction involving the consumer and the verifier based on the validation contexts, the digital ID documents requested by the verifier and the digital ID documents provided by the consumer. The algorithm iteratively makes predictions on the training data as to the appropriate prediction of the likelihood of fraud in a transaction, which may be represented as a score (“trust score”). Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict the likelihood of fraud in a transaction between the verifier and the consumer.

In one embodiment, such a model (artificial intelligence model) only utilizes the metadata associated with such requests and responses as opposed to the credentials or the information within such digital ID documents, which may be confidential, that were provided by the consumer.

In one embodiment, the artificial intelligence model built by machine learning engine 302 determines whether the transaction between the verifier and the consumer involves fraud based on matching the pattern in such a transaction with a previous pattern deemed to be a fraudulent transaction. In one embodiment, the artificial intelligence model detects the pattern of over or under sharing information based on the context of the transaction. In one embodiment, the artificial intelligence model detects the pattern of the consumer using inconsistent credentials, such as providing one digital ID documents that proves one aspect and then providing another digital ID documents that proves the opposite. For example, the consumer may provide a digital ID document that proves that the consumer is a homeowner and then provides another digital ID document that proves that the consumer is a renter.

In one embodiment, feedback is provided to the artificial intelligence model as to the accuracy of its output (“trust score”) in representing the likelihood of fraud in the transaction. Such feedback may be used by the model to improve its accuracy. In one embodiment, such feedback is used by a variance model to add or subtract a value from the trust score outputted by the artificial intelligence model.

In one embodiment, the variance model is used to dynamically adjust the trust score (raise or lower the score) of the artificial intelligence model based on various factors, such as the patterns of digital ID documents (e.g., order of the digital ID documents presented to the verifier from the consumer), variance in the digital ID documents requested by the verifier and provided by the consumer, discrepancies found in the digital ID documents provided by the consumer, inconsistencies found in the digital ID documents provided by the consumer, inconsistences between the transaction assumptions and the presented digital ID documents, etc. For example, based on the validation context to provide evidence of residence in the state of Texas, it would be assumed that the consumer presents a digital ID document from the state of Texas as opposed to presenting a digital ID document from another state.

In step 610, fraud detector engine 303 of fraud service broker 206 of authentication system 105 determines whether the score generated by the artificial intelligence model meets or exceeds a threshold value, which may be user-selected.

As stated above, fraud detector engine 303 is configured to inform computing device 103 of the verifier that there is evidence of fraud based on the value of the trust score generated by the artificial intelligence model discussed above. For example, if the value of the trust score does not meet or exceed a threshold value, which may be user-selected, then, in step 611, fraud detector engine 303 of fraud service broker 206 of authentication system 105 informs computing device 103 of the verifier, such as via email, instant messaging, etc., that there is evidence of fraud and to proceed with not accepting the alternative ID documents provided by the consumer, such as consumer 102.

Alternatively, if the value of the trust score meets or exceeds a threshold value, which may be user-selected, then, in step 612, fraud detector engine 303 of fraud service broker 206 of authentication system 105 informs computing device 103 of the verifier, such as via email, instant messaging, etc., that there is no evidence of fraud and to proceed with accepting the alternative ID documents provided by the consumer, such as consumer 102.

Fraud detector engine 303 performs such features using various software tools, including, but not limited to, Dynatrace®, Alteryx® Analytic Process Automation Platform™ IBM® Cognos Analytics, Sisense Fusion® Analytics, etc.

In this manner, the principles of the present disclosure enable the detection of suspicious behavior based on the pattern of digital ID documents requested and provided in the transaction involving the verifier and the consumer.

Furthermore, the principles of the present disclosure improve the technology or technical field involving fraud detection systems.

As discussed above, fraud detection is a set of processes and analyses that allow organizations to identify and prevent unauthorized activities. Such unauthorized activities may include fraudulent credit card transactions, identity theft, cyber hacking, insurance scams, and more. With an unlimited and rising number of ways someone can commit fraud, detection can be difficult. Activities, such as reorganization, moving to new information systems or encountering a cybersecurity breach could weaken an organization's ability to detect fraud. Techniques, such as real-time monitoring for fraud is generally recommended. Fraud detection systems typically search for patterns or anomalies of suspicious behavior as a general focus for fraud detection. Such patterns and anomalies of suspicious behavior are detected based on current data or device use patterns. For example, data analysts may attempt to prevent insurance fraud by creating algorithms to detect patterns and anomalies of suspicious behavior based on current data or device use patterns. Unfortunately, by simply detecting patterns and anomalies of suspicious behavior based on current data or device use patterns, many fraudulent activities will not be detected.

Embodiments of the present disclosure improve such technology by detecting requests to provide digital identification (ID) document(s) to a computing device of a verifier by a computing device of a consumer based on a validation context. “Validation context,” as used herein, refers to the circumstances that determine which ID requirements should be requested of the consumer by the verifier. For example, in order to validate the state in which the consumer lives, the verifier may request the consumer to provide a license or vehicle registration. In such an example, the validation context corresponds to validating the state in which the consumer lives. A “consumer” (also referred to as the “device holder”), as used herein, refers to the individual who desires to partake in an activity or event but is required to present digital identification (ID) documents to the verifier (e.g., government agency) to prove that the consumer meets the ID requirements to engage in such an activity or event, such as proof of age, residence, location, etc. “Verifier,” as used herein, refers to the entity (e.g., government agency, government official, merchant, etc.) that is responsible for verifying that the consumer meets the ID requirements for partaking in an associated activity or event. A “digital ID document,” as used herein, is an electronic equivalent of an individual identity card as well as other forms of user information, such as pay stubs, utility bills, restaurant receipts, etc. Furthermore, in addition to detecting requests to provide digital ID document(s) to the computing device of the verifier, responses to such requests are detected in which the computing device of the consumer provides digital ID document(s) to the computing device of the verifier. A score is then generated corresponding to a likelihood of fraud in the transaction involving the consumer and the verifier using an artificial intelligence model based on the validation context, the digital ID document(s) requested to be provided by the computing device of the consumer to the computing device of the verifier and the digital ID document(s) provided to the computing device of the verifier by the computing device of the consumer. The computing device of the verifier may then be informed that there is evidence of fraud based on a value of the score, such as when the value of the score does not meet or exceed a threshold value. In this manner, suspicious behavior is detected based on the pattern of digital ID documents requested and provided in the transaction involving the verifier and the consumer. Furthermore, in this manner, there is an improvement in the technical field involving fraud detection systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for identifying suspicious behavior, the method comprising:
detecting requests to provide one or more digital identification (ID) documents to a computing device of a verifier by a computing device of a consumer based on a validation context;
detecting responses to said requests in which said computing device of said consumer provides one or more digital ID documents to said computing device of said verifier;
generating a score corresponding to a likelihood of fraud in a transaction involving said consumer and said verifier using an artificial intelligence model based on said validation context, said one or more digital ID documents requested to be provided by said computing device of said consumer to said computing device of said verifier and said one or more digital ID documents provided to said computing device of said verifier by said computing device of said consumer; and
informing said computing device of said verifier that there is evidence of fraud based on a value of said score.

2. The method as recited in claim 1 further comprising:
detecting a first request for an initial set of digital identification (ID) documents to be provided to said computing device of said verifier by said computing device of said consumer based on said validation context;
detecting a first response to said first request that provides a subset of said initial set of digital ID documents to said computing device of said verifier from said computing device of said consumer;
identifying one or more alternative digital ID documents to replace one or more digital ID documents in said initial set of digital ID documents that were requested but not provided in said subset of said initial set of digital ID documents;
detecting a second request for said identified one or more alternative digital ID documents to be provided to said computing device of said verifier by said computing device of said consumer;
detecting a second response to said second request for said identified one or more alternative digital ID documents in which said computing device of said consumer provides a second set of one or more digital ID documents to said computing device of said verifier; and
generating said score corresponding to said likelihood of fraud in said transaction involving said consumer and said verifier using said artificial intelligence model based on said validation context, said initial set of digital ID documents, said subset of said initial set of digital ID documents, said one or more alternative digital ID documents and said second set of one or more digital ID documents.

3. The method as recited in claim 2 further comprising:
informing said computing device of said verifier to not accept said second set of one or more digital ID documents in response to said value of said score not meeting or exceeding a threshold value.

4. The method as recited in claim 2 further comprising:
informing said computing device of said verifier to accept said second set of one or more digital ID documents in response to said value of said score meeting or exceeding a threshold value.

5. The method as recited in claim 1, wherein said computing device of said verifier is informed that there is evidence of fraud in response to said value of score not meeting or exceeding a threshold value.

6. The method as recited in claim 1, wherein said artificial intelligence model utilizes historical patterns of digital ID documents requested by verifiers and provided by consumers for various validation contexts corresponding to cases of fraud in determining said score corresponding to said likelihood of fraud in said transaction involving said consumer and said verifier.

7. The method as recited in claim 6, wherein said artificial intelligence model uses metadata from said digital ID documents requested by said verifiers and provided by said consumers for various validation contexts to form said historical patterns of digital ID documents requested by said verifiers and provided by said consumers for various validation contexts.

8. A computer program product for identifying suspicious behavior, the computer program product comprising one or more computer readable storage mediums having program code embodied therewith, the program code comprising programming instructions for:
detecting requests to provide one or more digital identification (ID) documents to a computing device of a verifier by a computing device of a consumer based on a validation context;
detecting responses to said requests in which said computing device of said consumer provides one or more digital ID documents to said computing device of said verifier;
generating a score corresponding to a likelihood of fraud in a transaction involving said consumer and said verifier using an artificial intelligence model based on said validation context, said one or more digital ID documents requested to be provided by said computing device of said consumer to said computing device of said verifier and said one or more digital ID documents provided to said computing device of said verifier by said computing device of said consumer; and
informing said computing device of said verifier that there is evidence of fraud based on a value of said score.

9. The computer program product as recited in claim 8, wherein the program code further comprises the programming instructions for:
detecting a first request for an initial set of digital identification (ID) documents to be provided to said computing device of said verifier by said computing device of said consumer based on said validation context;
detecting a first response to said first request that provides a subset of said initial set of digital ID documents to said computing device of said verifier from said computing device of said consumer;
identifying one or more alternative digital ID documents to replace one or more digital ID documents in said initial set of digital ID documents that were requested but not provided in said subset of said initial set of digital ID documents;
detecting a second request for said identified one or more alternative digital ID documents to be provided to said computing device of said verifier by said computing device of said consumer;
detecting a second response to said second request for said identified one or more alternative digital ID documents in which said computing device of said consumer provides a second set of one or more digital ID documents to said computing device of said verifier; and
generating said score corresponding to said likelihood of fraud in said transaction involving said consumer and said verifier using said artificial intelligence model based on said validation context, said initial set of digital ID documents, said subset of said initial set of digital ID documents, said one or more alternative digital ID documents and said second set of one or more digital ID documents.

10. The computer program product as recited in claim 9, wherein the program code further comprises the programming instructions for:
informing said computing device of said verifier to not accept said second set of one or more digital ID documents in response to said value of said score not meeting or exceeding a threshold value.

11. The computer program product as recited in claim 9, wherein the program code further comprises the programming instructions for:
informing said computing device of said verifier to accept said second set of one or more digital ID documents in response to said value of said score meeting or exceeding a threshold value.

12. The computer program product as recited in claim 8, wherein said computing device of said verifier is informed that there is evidence of fraud in response to said value of score not meeting or exceeding a threshold value.

13. The computer program product as recited in claim 8, wherein said artificial intelligence model utilizes historical patterns of digital ID documents requested by verifiers and provided by consumers for various validation contexts corresponding to cases of fraud in determining said score corresponding to said likelihood of fraud in said transaction involving said consumer and said verifier.

14. The computer program product as recited in claim 13, wherein said artificial intelligence model uses metadata from said digital ID documents requested by said verifiers and provided by said consumers for various validation contexts to form said historical patterns of digital ID documents requested by said verifiers and provided by said consumers for various validation contexts.

15. A system, comprising:
a memory for storing a computer program for identifying suspicious behavior; and
a processor connected to said memory, wherein said processor is configured to execute program instructions of the computer program comprising:
detecting requests to provide one or more digital identification (ID) documents to a computing device of a verifier by a computing device of a consumer based on a validation context;
detecting responses to said requests in which said computing device of said consumer provides one or more digital ID documents to said computing device of said verifier;
generating a score corresponding to a likelihood of fraud in a transaction involving said consumer and said verifier using an artificial intelligence model based on said validation context, said one or more digital ID documents requested to be provided by said computing device of said consumer to said computing device of said verifier and said one or more digital ID documents provided to said computing device of said verifier by said computing device of said consumer; and
informing said computing device of said verifier that there is evidence of fraud based on a value of said score.

16. The system as recited in claim 15, wherein the program instructions of the computer program further comprise:
detecting a first request for an initial set of digital identification (ID) documents to be provided to said computing device of said verifier by said computing device of said consumer based on said validation context;
detecting a first response to said first request that provides a subset of said initial set of digital ID documents to said computing device of said verifier from said computing device of said consumer;
identifying one or more alternative digital ID documents to replace one or more digital ID documents in said initial set of digital ID documents that were requested but not provided in said subset of said initial set of digital ID documents;
detecting a second request for said identified one or more alternative digital ID documents to be provided to said computing device of said verifier by said computing device of said consumer;
detecting a second response to said second request for said identified one or more alternative digital ID documents in which said computing device of said consumer provides a second set of one or more digital ID documents to said computing device of said verifier; and
generating said score corresponding to said likelihood of fraud in said transaction involving said consumer and said verifier using said artificial intelligence model based on said validation context, said initial set of digital ID documents, said subset of said initial set of digital ID documents, said one or more alternative digital ID documents and said second set of one or more digital ID documents.

17. The system as recited in claim 16, wherein the program instructions of the computer program further comprise:
informing said computing device of said verifier to not accept said second set of one or more digital ID documents in response to said value of said score not meeting or exceeding a threshold value.

18. The system as recited in claim 16, wherein the program instructions of the computer program further comprise:
informing said computing device of said verifier to accept said second set of one or more digital ID documents in response to said value of said score meeting or exceeding a threshold value.

19. The system as recited in claim 15, wherein said computing device of said verifier is informed that there is evidence of fraud in response to said value of score not meeting or exceeding a threshold value.

20. The system as recited in claim 15, wherein said artificial intelligence model utilizes historical patterns of digital ID documents requested by verifiers and provided by consumers for various validation contexts corresponding to cases of fraud in determining said score corresponding to said likelihood of fraud in said transaction involving said consumer and said verifier.
